(19) United States
(12) Patent Application Publication
(10) Pub. No.: US 2009/0089216 A1
(43) Pub. Date: Apr. 2, 2009

(54) Method and system for generating a negotiation

(76) Inventors: Manish Srivastava, San Carlos, CA (US); Ngai-Ming Wang, Fremont, CA (US); Kareem Benjamin, San Francisco, CA (US); Ramani Ranjan Jagadeba, Sunnyvale, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(21) Appl. No.: 10/185,143

(22) Filed: Jun. 27, 2002

(51) Int. Cl. G06Q 30/00

(52) U.S. Cl. 705/80; 705/26

(57) ABSTRACT

A method for generating a negotiation. A request to generate a negotiation is received, wherein the request comprises a negotiation type. Common data and meta-data are accessed, wherein the meta-data is associated with the negotiation type and comprises at least one rule describing the negotiation type. A first user interface is rendered based on the common data and the meta-data, wherein the first user interface is rendered specific to the negotiation type and prompts for a user response defining a term of the negotiation. In response to the user response, the negotiation is generated based on the user response and the meta-data.

### FIELD OF INVENTION

Embodiments of the present invention pertain to the field of electronic commerce. More particularly, the present invention relates to a method and system for generating a negotiation in electronic commerce buying and selling operations.

### BACKGROUND OF THE INVENTION

Buyers and sellers use a variety of techniques to ensure goods and services meet their mutual expectations. However, traditional procurement systems have been proven to be error prone, labor intensive, and costly operations. For example, often times, when a buyer is looking to purchase a batch of articles, a buyer might negotiate terms for the purchase prior to making the purchasing decision. The negotiation allows the buyer and seller to ensure the articles and terms (e.g., price, quantity, delivery conditions, etc.) will meet any specific requirements. Traditional buying and selling mediums, such as auctions, catalog based purchasing, and selling, and the like, do not always facilitate the most efficient matching of requirements. The recent ascendancy of electronic commerce provides a means of avoiding, or at least reducing, the problems presented by the use of traditional buying and selling mediums.

In many respects, the Internet and the World Wide Web based network technologies have largely eliminated the most labor intensive and costly portions of the buying and selling type commerce operations (e.g., the use of mass mailings, printed specifications, catalogs, updating preprinted product information, etc.). To take advantage of advances in network technology, a variety of electronic commerce facilitating schemes have been developed. One such scheme involved the use of business-to-business buying and selling exchanges implemented on the Internet. The term “electronic commerce” or “e-commerce” originally evolved from remote forms of electronic shopping to mean all aspects of business and market processes enabled by wide area communications networks, namely, the Internet and the World Wide Web based network technologies. E-commerce is a rapidly growing field, and is generally understood to mean doing business on-line or selling and buying products and services through Web (e.g., Internet based) storefronts or through other similar distributed computer networks. In general, electronic commerce is substantially similar to the more traditional catalog based commerce schemes. The business-to-business e-commerce exchanges, or simply “B2B exchanges” have evolved to focus on the specific needs and requirements of buying and selling between businesses.

As the use of B2B exchanges has proliferated, the implementation of electronic commerce negotiations has become increasingly common. There are many different types of negotiations currently used in electronic commerce. Among the most widely utilized are a request for information (RFI), a request for a quote (RFQ), collectively referred to as RFXs, and an auction.

An RFI is often sent by a business looking to source components for a product. Typically, an RFI is sent at an early phase of a negotiation. For example, a car manufacturer requires tires for a newly designed car. The tires must meet certain specifications (e.g., cost, reliability, quality). The car manufacturer would send an RFI to a tire manufacturer inquiring as to whether a tire with the required specifications can be built.

An RFQ is a request for a detailed quote based on a specification. An RFQ is often sent upon receiving a response from an RFI. Continuing with the example above, an RFQ sent to a tire manufacture would include specific requests regarding the tires (e.g., price, delivery date, freight charges, tooling costs, research and development costs).

An auction generally aggregates buyers or sellers to purchase or sell items/services through the respective submission of competitive bids. An auction is typically performed at a later phase of a negotiation. Generally, the most competitive bid is designated the winner of the auction. For example, in an auction amongst multiple competing buyers, the most competitive bid is usually the bid offering the most money for the specified item or service. In an auction amongst multiple competing sellers, the most competitive bid is usually the bid offering the specified item or service for the lowest price. Thus, buyers and sellers participating in an auction compete with one another on the basis of the terms of their bids. Auctioneers have an interest in making the bidding process as competitive as possible to effect the most efficient matching of requirements between sellers and buyers (e.g., getting the best deal). Large numbers of buyers or sellers competitively trying to outbid one another usually leads to the most favorable terms.

Typical businesses and organizations perform a large number of electronic commerce negotiations. Furthermore, the negotiations are often of a different type, depending on the nature of the product or service and the current phase of the negotiation. Currently, a business requires a different management tool for each type of negotiation they perform. For example, where a business typically performs RFIs, RFQs and auctions, they would require three separate management tools, one for each negotiation type.

There are several drawbacks to having multiple negotiation management tools. First, as a typical negotiation includes multiple negotiation types, there is a large amount of redundant data entry. For example, once a business completes an RFQ for an item, a new management tool for an auction must be accessed, and all data from the RFQ necessary for the auction must be reentered. Furthermore, it is typically not possible to view information across the different types of negotiations for a product. In most cases, it is not possible to go back and forth between negotiation management tools. For example, if a business has multiple negotiations at different phases of the negotiations, they would have to switch negotiation management tools each time they want to switch to a different negotiation type.

Additionally, maintaining separate negotiation management tools for each negotiation is typically expensive. Having more tools requires more technical support, more training, more hardware, and more upgrade/patch costs. Furthermore, having multiple tools that support different data formats requires even more training and support costs.

### SUMMARY OF THE INVENTION

Accordingly, a need exists for a method for generating a negotiation that requires only one negotiation management tool, regardless of the type of the negotiation. A need also exists that satisfies the above need, and allows for viewing of information across different types of negotiations. A need also exists that satisfies the above needs, and allows for switching between negotiation types without switching negotiation management tools. A need also exists that satisfies the above needs, and is less expensive than current negotiation management tools.

A method and system for generating a negotiation is presented. A request to generate a negotiation is received, wherein the request comprises a negotiation type. In one embodiment, the negotiation type is an auction. In another embodiment, the negotiation type is a request for information (RFI). In another embodiment, the negotiation type is a request for a quote (RFQ). In another embodiment, the negotiation type is an offer/counteroffer negotiation.

Common data and meta-data are accessed, wherein the meta-data is associated with the negotiation type and comprises at least one rule describing the negotiation type. In one embodiment, the rule describes terminology specific to said negotiation type. A first user interface is rendered based on the common data and the meta-data, wherein the first user interface is rendered specific to the negotiation type and prompts for a user response defining a term of the negotiation. In response to the user response, the negotiation is generated based on the user response and the meta-data.

In one embodiment, the negotiation is published to at least one participant. A second user interface is rendered based on the negotiation, wherein the second user interface prompts for a second user response characterizing the term of the negotiation.

In one embodiment, in response to the second user response, a third user interface is rendered based on the second user response and the meta-data. The third user interface presents the second user response specific to the negotiation type.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a block diagram of an electronic commerce negotiation operation in accordance with one embodiment of the present invention.

FIG. 2 illustrates a block diagram of an electronic commerce negotiation operation in accordance with an alternative embodiment of the present invention.

FIG. 3 illustrates a flowchart showing steps in a process for generating a negotiation in accordance with one embodiment of the present invention.

FIGS. 4A-C illustrate exemplary screen shots of a first user interface in accordance with one embodiment of the present invention.

FIGS. 5A-C illustrate exemplary screen shots of a second user interface in accordance with one embodiment of the present invention.

FIGS. 6A-C illustrate exemplary screen shots of a third user interface in accordance with one embodiment of the present invention.

FIG. 7 illustrates a block diagram of an exemplary computer system upon which embodiments of the present invention may be implemented.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention. However, it will be apparent to one skilled in the art that the present invention may be practiced without these specific details. In other instances, well-known methods, procedures, components, structures and devices have not been described in detail so as to avoid unnecessarily obscuring aspects of the present invention.

The present invention provides a method and system for generating a negotiation. Embodiments of the present invention provide a method and system for generating a negotiation that requires only one negotiation management tool, regardless of the type of the negotiation. Additionally, embodiments of the present invention provide a method and system that allows for viewing of information across different types of negotiations and for switching between negotiation types without switching negotiation management tools. Additionally, embodiments of the present invention provide a method and system that is less expensive than current negotiation management tools.

It should be appreciated that embodiments of the present invention may generate a negotiation. For purposes of the present application, the term “item” is understood to refer to both items and/or services. Furthermore, embodiments of the present invention also apply to requests for information (RFIs), requests for proposals (RFPs), and requests for quotes (RFQs), as well as auctions. For purposes of the present application, the term “negotiation” is understood to collectively refer to RFIs, RFPs and RFQs (collectively RFXs), auctions, offer/counteroffer negotiations, and any other type of negotiation.

Embodiments of the present invention may be directed towards private and public exchanges, wherein private exchanges are scenarios having one negotiator and many participants, and wherein public exchanges have many negotiators and many participants. For purposes of simplicity, the present application refers to private exchanges.

### NOTATION AND NOMENCLATURE

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “receiving” or “rendering” or “accessing” or “generating” or “publishing” or “prompting” or the like, may refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### METHOD AND SYSTEM FOR GENERATING A NEGOTIATION

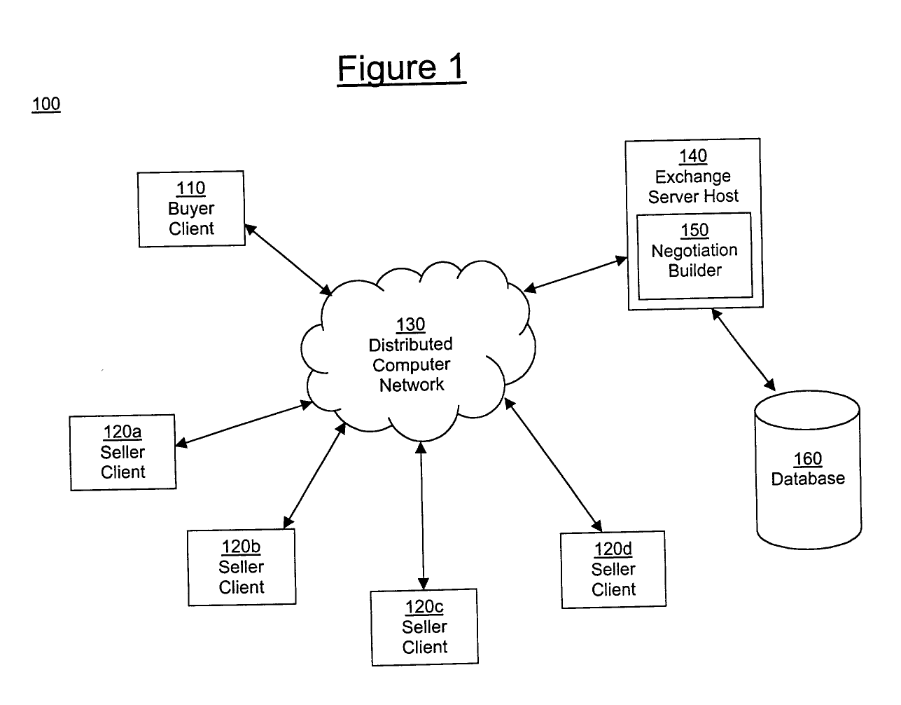

Referring now to FIG. 1, a diagram of an electronic negotiation system 100 in accordance with one embodiment of the present invention is shown. As depicted in FIG. 1, system 100 includes an exchange server host 140 communicatively coupled to a buyer client 110 and a plurality of seller clients 120a-d via a distributed computer network 130. In one embodiment, exchange server host is also coupled to database 160. Negotiation operations in accordance with system 100 are at times referred to as “reverse negotiations” or “procurement negotiations” where sellers submit competing response to sell specified products and/or services to a buyer. It should be appreciated that seller responses may be bids, quotes, counteroffers, or any other information requested by the buyer.

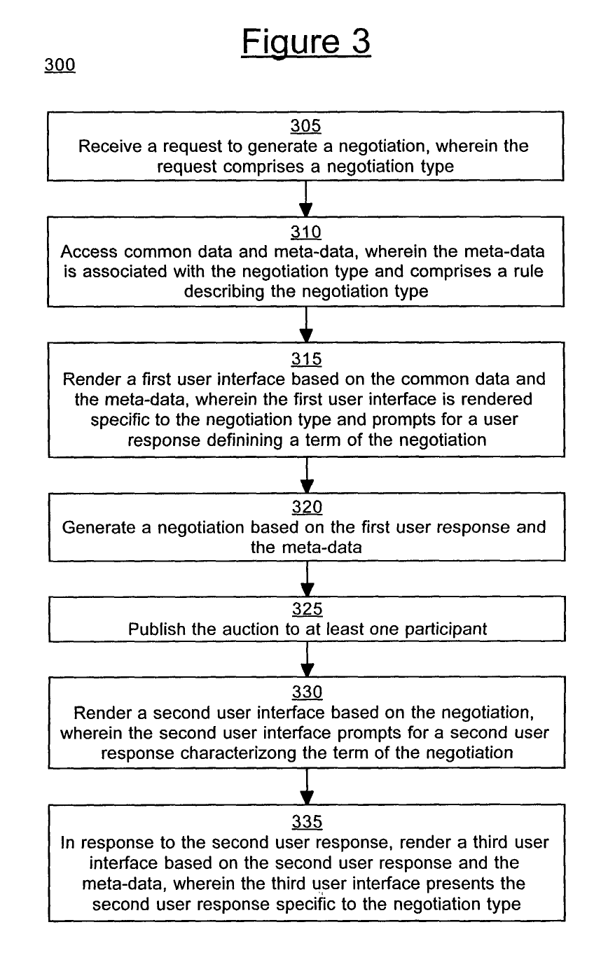

The exchange server host 140 functions as the central communications point for the negotiation operations, by conducting data collection and management of item information (e.g., items, services, or the like) and the negotiation characteristics and terms provided by buyer clients, such as buyer client 110, and negotiation bid or quote information provided by the seller clients 120a-d. In one embodiment, exchange server host 140 comprises negotiation builder 150. In one embodiment, negotiation builder 150 performs a method for generating a negotiation (e.g., process 300 of FIG. 3). In one embodiment, negotiation builder 150 accesses meta-data stored within database 160 for defining rules used to generate a negotiation and perform a negotiation.

Buyer client 110 and seller clients 120a-d communicate with exchange server host 140 via the communications protocols of distributed computer network 130, hereafter simply network 130. Negotiation builder 150 conducts the negotiation operations on the basis of responses received from buyer client 110 and seller clients 120a-d.

A typical negotiation operation comprises negotiation builder 150 generating a negotiation based on responses received from buyer client 110. In one embodiment, the negotiation is published to seller clients 120a-d, who then submit responses characterizing the terms of the negotiation. The responses are transmitted from seller clients 120a-d to negotiation builder 150 via network 130. Upon the completion of the negotiation, in one embodiment of the present invention, negotiation builder 150 transmits a negotiation summary to buyer client 110.

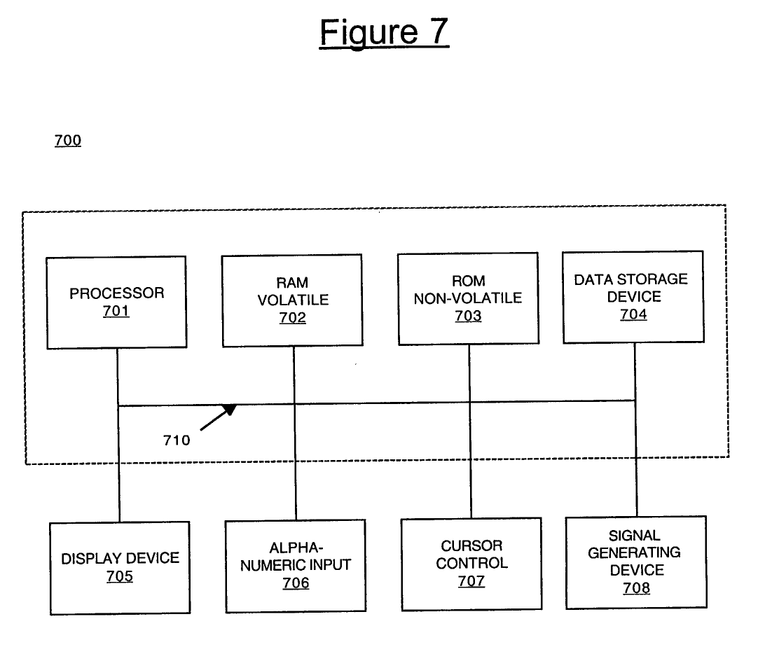

It should be noted that the embodiment of the present invention depicted in FIG. 1 (e.g., system 100) is implemented as a software based process cooperatively executing on the respective computer system platforms of both exchange server host 140 and seller clients 120a-d. The basic components of the computer system platforms are shown in the example computer system 700 of FIG. 7 below.

Referring still to FIG. 1, network 130 includes well know network technologies. For example, network 130 can be implemented using LAN technologies (e.g., Ethernet, Tokenring, etc.), the Internet, or other wired or wireless network technologies. The communications links between exchange server host 140, buyer client 110, seller clients 120a-d, network 130 and database 160 can be implemented using, for example, a telephone circuit, communications cable, optical cable, wireless link, or the like.

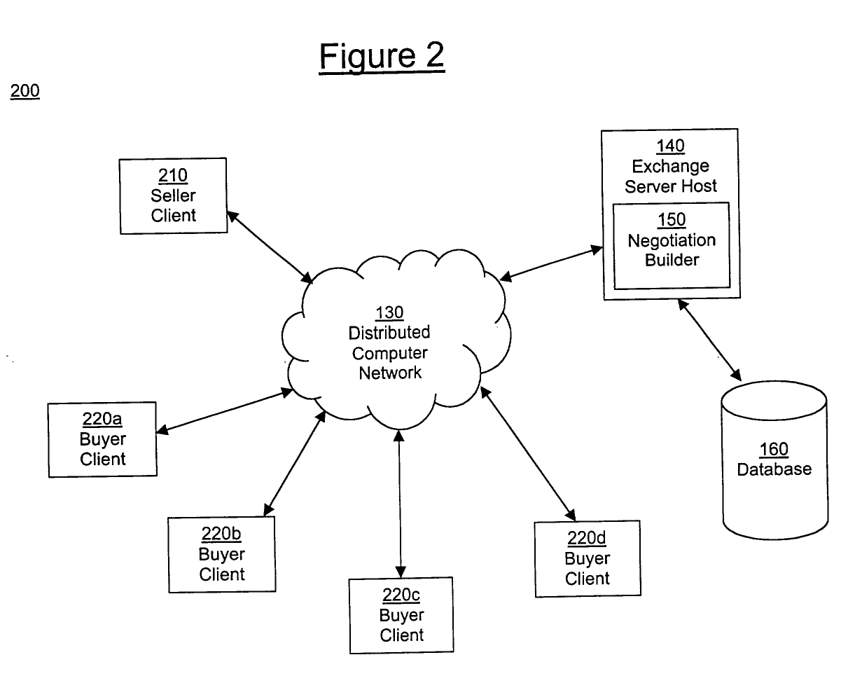

FIG. 2 shows a system 200 in accordance with an alternative embodiment of the present invention. System 200 is substantially similar to system 100 of FIG. 1, however, system 200 depicts an auction operation wherein competing buyer clients 220a-d submit responses to buy products or services from a seller client 210. Negotiation operations in accordance with system 200 are at times referred to as “forward negotiations” or where buyers submit competing responses' to purchase specified items and/or services from a seller.

The negotiation operation depicted in FIG. 2 comprises negotiation builder 150 generating a negotiation based on responses received from seller client 210. In one embodiment, the negotiation is published to buyer clients 220a-d, who then submit responses characterizing the terms of the negotiation. The responses are transmitted from buyer clients 220a-d to negotiation builder 150 via network 130. Upon the completion of the negotiation, in one embodiment of the present invention, negotiation builder 150 transmits a negotiation summary to seller client 210.

FIG. 3 illustrates a flowchart showing steps in a process 300 for generating a negotiation in accordance with one embodiment of the present invention. In one embodiment, process 300 is carried out by processors and electrical components under the control of computer readable and computer executable instructions. Although specific steps are disclosed in process 300, such steps are exemplary. That is, the embodiments of the present invention are well suited to performing various other steps or variations of the steps recited in FIG. 3. As depicted in FIG. 3, process 300 diagrams the operating process of generating a negotiation as performed by, for example, negotiation builder 150 of FIG. 1, as a buyer performs an negotiation to buy an item from multiple competing sellers.

At step 305 of process 300, a request to generate a negotiation (e.g., a business document) is received, wherein the request comprises a negotiation type. The negotiation type indicates which type of negotiation a negotiator desires to perform. In one embodiment, the negotiation type is an auction. In another embodiment, the negotiation type is a request for information (RFI). In another embodiment, the negotiation type is a request for a quote (RFQ). In another embodiment, the negotiation type is an offer/counteroffer negotiation. It should be appreciated that embodiments of the present invention may perform any form of negotiation desired by a negotiator, and is not intended to be limited to the above embodiments. In one embodiment, the negotiation type is a user-configured negotiation.

Embodiments of the present invention provide a method for generating an offer/counteroffer negotiation. In an offer/counteroffer negotiation, characteristics of an offer for an item are received, wherein the characteristics comprise at least one term defining the offer. The offer is published to a plurality of bidders. Among the potential responses to the offer, at least one counteroffer is received from a bidder. The counteroffer comprises at least one alternative term. Provided the counteroffer is acceptable, the counteroffer is accepted. Provided the counteroffer is not acceptable, a second counteroffer is transmitted to the bidder, wherein the second counteroffer comprising at least one alternative term with respect to the counteroffer. The offer/counteroffer negotiation allows a negotiator to negotiate terms with one or more bidders individually, outside the constraints of a traditional auction. For additional descriptions regarding an offer/counteroffer negotiation, refer to commonly assigned U.S. Patent, Serial Number______, Attorney Docket Number ORCL-2001-252-01, entitled “A METHOD AND SYSTEM FOR IMPLEMENTING AN OFFER/COUNTEROFFER NEGOTIATION”, issued to Kareem Benjamin et al., with filing date______.

At step 310, common data and meta-data are accessed, wherein the meta-data is associated with the negotiation type is accessed. The meta-data comprises at least one rule describing the negotiation type. In one embodiment, the common data and meta-data are stored on a database (e.g., database 160 of FIG. 1). The common data comprises data for all negotiation types supported by the negotiation builder. In one embodiment, the meta-data, being associated with a particular negotiation type, controls how the common data is displayed and how it behaves. For example, for different negotiation types, the negotiator must enter in different information. In other words, information used in some negotiations is not used in other negotiations.

As described above, it should be appreciated that a user-configured negotiation may be requested. A user-configured negotiation comprises user-configured meta-data defining the rules of the negotiation. In one embodiment, user-configured meta-data is generated by altering the meta-data associated with another negotiation type. Embodiments of the present invention provide a flexible management tool by allowing for customizable negotiation types.

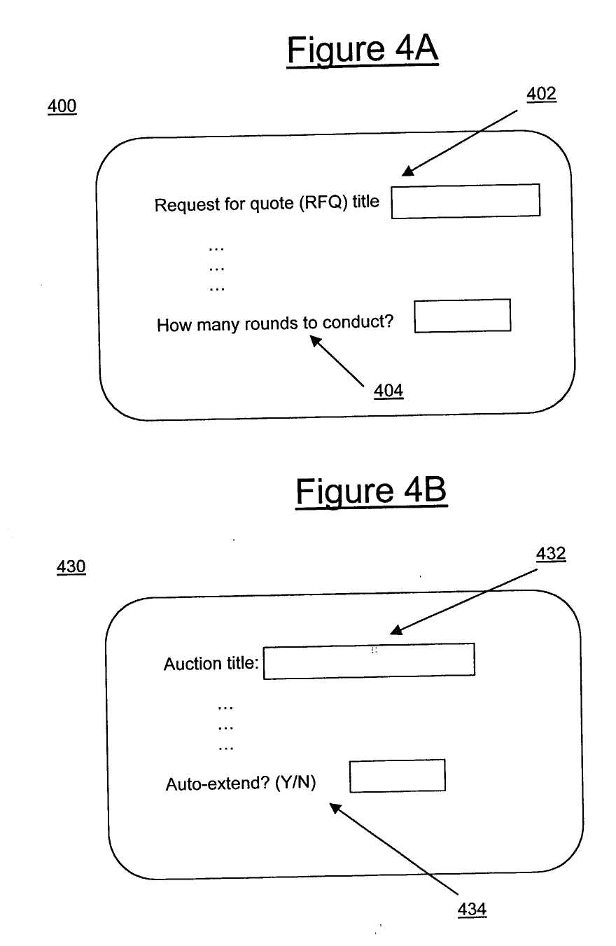

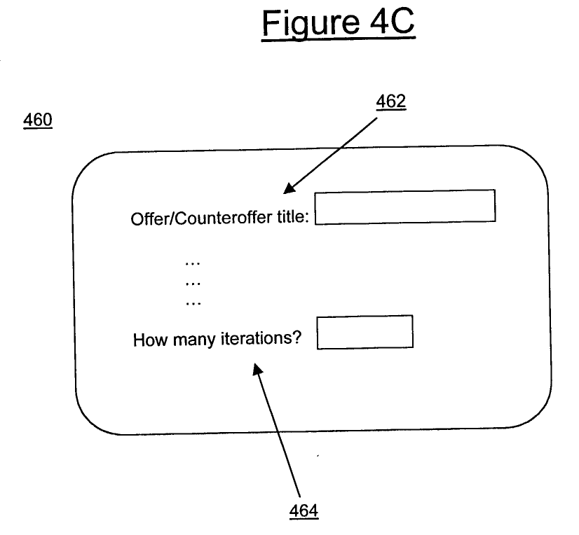

At step 315, a first user interface is rendered based on the common data and the meta-data. The first user interface is rendered specific to the negotiation type and prompts for a user response defining a term of the negotiation. In one embodiment, the meta-data defines the fields of and the terminology used within the first user interface, wherein the first user interface prompts for a first user response to the field. FIGS. 4A-C illustrate exemplary screen shots of a first user interface in accordance with one embodiment of the present invention.

It should be appreciated that, in one embodiment, the meta-data can establish a default value for a field. For example, an auction is typically open to public bidding while RFQ participation is typically by invitation only. As such, for a field determining whether a negotiation is open to the public, for an auction the field will default to “Yes” and for an RFQ the field will default to “No.” It should be appreciated that the negotiator may change the default value for a field.

Furthermore, it should be appreciated that, in one embodiment, the meta-data can determine whether a field is required for a negotiation. For example, in an auction, a price typically must be submitted. However, in an RFI, a price may not be required. As such, the meta-data dictates that an auction must have a price field while a price field is not required in an RFI.

FIG. 4A illustrates an exemplary screenshot of a first user interface 400 for an RFQ negotiation. First user interface 400 comprises an RFQ title field (e.g., term) 402, and at least one RFQ information field 404. It should be appreciated that first user interface 400 is rendered to display information necessary to generate an RFQ. Accordingly, RFQ information field 404 requests information pertinent to the design of an RFQ negotiation. In one embodiment, RFQ information field 404 asks for an input of how many rounds are to be conducted. It should be appreciated that in an RFQ, a negotiator often desires more than one round of RFQs. The meta-data for an RFQ negotiation type defines which data of the common data is displayed and what terminology is used to present the common data.

FIG. 4B illustrates an exemplary screenshot of a first user interface 430 for an auction. First user interface 430 comprises an auction title field (e.g., term) 432, and at least one auction information field 434. It should be appreciated that the terminology used in first user interface 430 is specific to an auction. It should further be appreciated that first user interface 430 is rendered to display information necessary to generate an auction. Accordingly, auction information field 434 requests information pertinent to the design of an auction. In one embodiment, auction information field 434 asks whether an auto-extend feature should be enabled. It should be appreciated that in an auction, a negotiator often desires the auto-extend feature. The auto-extend feature operates to automatically extend the end time of an auction based on auction activity in the minutes preceding the end time. On the contrary, an auction does not typically comprise a plurality of rounds. As such, the information request in RFQ information field 404 of FIG. 4A, regarding how many rounds should be conducted, is not displayed. The meta-data for an auction negotiation type defines which data of the common data is displayed and what terminology is used to present the common data.

FIG. 4C illustrates an exemplary screenshot of a first user interface 460 for an offer/counteroffer negotiation. First user interface 460 comprises an offer/counteroffer title field (e.g., term) 462, and at least one offer/counteroffer information field 464. It should be appreciated that the terminology used in first user interface 460 is specific to an offer/counteroffer negotiation. It should further be appreciated that first user interface 460 is rendered to display information necessary to generate an offer/counteroffer negotiation. Accordingly, offer/counteroffer information field 464 requests information pertinent to the design of an offer/counteroffer negotiation. In one embodiment, offer/counteroffer information field 464 asks how many iterations are allowed. It should be appreciated that in an offer/counteroffer negotiation, a negotiator often desires to limit the number of iterations. The meta-data for an offer/counteroffer negotiation type defines which data of the common data is displayed and what terminology is used to present the common data.

With reference to FIG. 3, at step 320, in response to the user response, the negotiation is generated based on the user response and the meta-data. At step 325, the negotiation is published to at least one participant. In one embodiment, the negotiation is published over a distributed computer network (e.g., distributed computer network 130 of FIGS. 1 and 2). In one embodiment, the negotiation is published by transmitting an electronic message to potential negotiation participants. It should be appreciated that the negotiation can be published in any way intended to appraise potential participants of the existence of the negotiation.

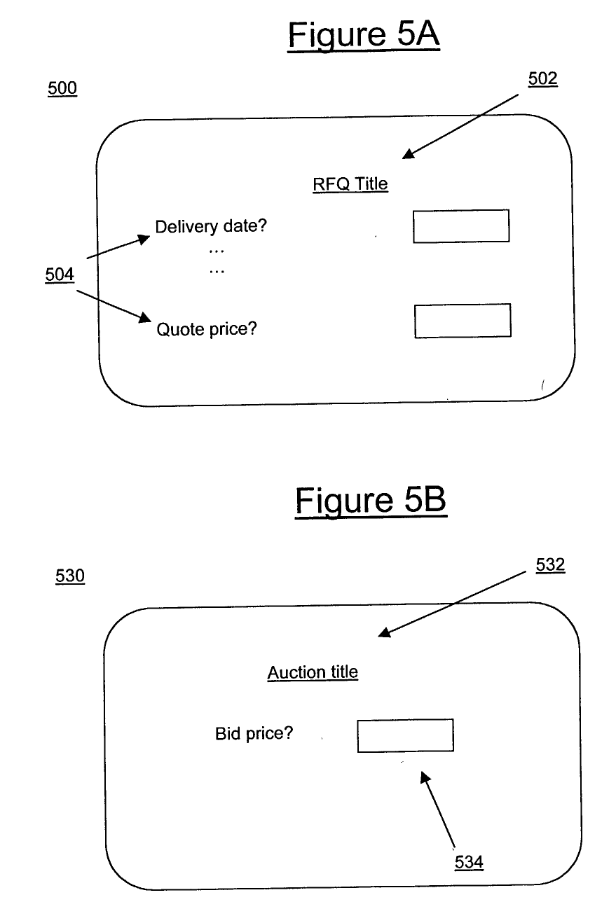

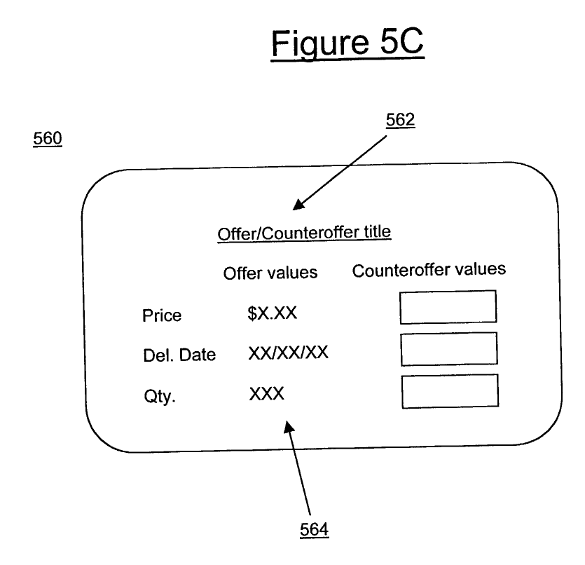

At step 330, a second user interface is rendered based on the negotiation. The second user interface is rendered specific to the negotiation type and prompts for a second user response characterizing the terms of the negotiation. It should be appreciated that in characterizing the terms of the negotiation, the second user response will provide requested information in the appropriate style. In one embodiment, the second user interface prompts for a second user response in response to the fields. For example, if the term prompts for a price, the second user response will be in numerical format. Similarly, if the term prompts for a delivery date, the second user response will be in the appropriate date format. In one embodiment, the meta-data defines the fields of and the terminology used within the second user interface, wherein the second user interface prompts for a second user response to the field. FIGS. 5A-C illustrate exemplary screen shots of a second user interface in accordance with one embodiment of the present invention.

FIG. 5A illustrates an exemplary screenshot of a second user interface 500 for an RFQ negotiation. Second user interface 500 comprises an RFQ title 502, and at least one RFQ information field 504. It should be appreciated that second user interface 500 is rendered to prompt for information necessary to operate an RFQ. Accordingly, RFQ information field 504 prompts for information necessary to operate an RFQ negotiation as generated at step 320 of FIG. 3. In one embodiment, RFQ information field 504 prompts for a delivery date. In another embodiment, RFQ information field 504 prompts for a quote price.

FIG. 5B illustrates an exemplary screenshot of a second user interface 530 for an auction. Second user interface 530 comprises an auction title 532 and at least one auction information field 534. It should be appreciated that the terminology used in second user interface 530 is specific to an auction. It should further be appreciated that second user interface 530 is rendered to prompt for information requested in an auction. Accordingly, auction information field 534 requests information pertinent to the auction as generated at step 320 of FIG. 3. In one embodiment, auction information field 534 asks for a bid price. It should be appreciated that in an auction, the only field typically prompted for is a bid price.

FIG. 5C illustrates an exemplary screenshot of a second user interface 560 for an offer/counteroffer negotiation. Second user interface 560 comprises an offer/counteroffer title 562 and at least one offer/counteroffer information field 564. It should be appreciated that the terminology used in second user interface 560 is specific to an offer/counteroffer negotiation. It should further be appreciated that second user interface 560 is rendered to prompt for information requested in an offer/counteroffer negotiation. Accordingly, offer/counteroffer information field 564 requests information pertinent to the offer/counteroffer negotiation as generated at step 320 of FIG. 3. In one embodiment, offer/counteroffer information field 564 prompts for a price, a delivery data, and a quantity. In one embodiment, offer/counteroffer information field 564 provides the values of the offer, and prompts for counteroffer values.

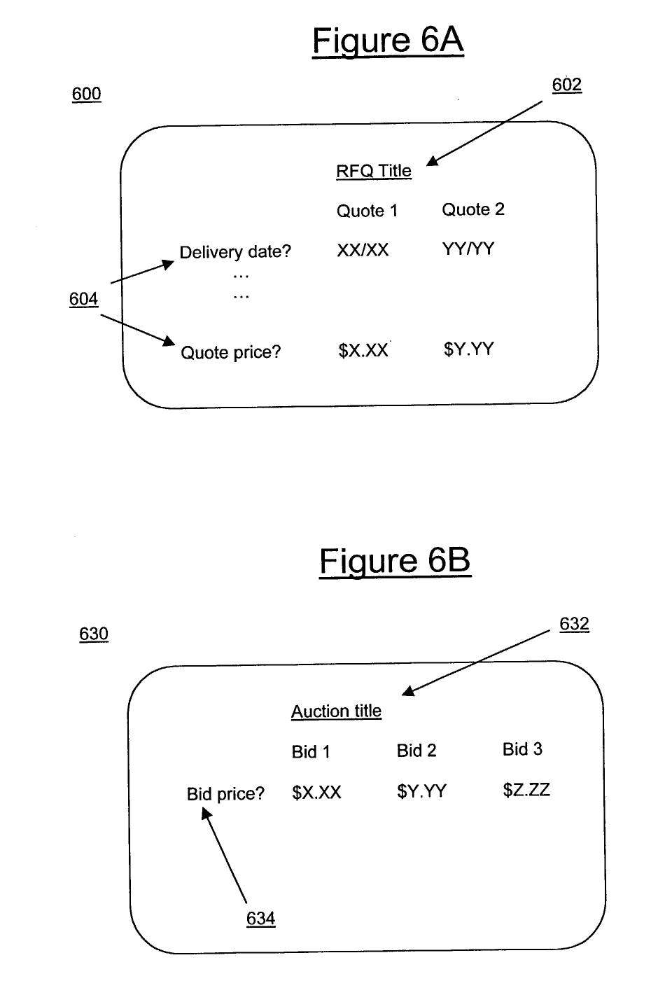

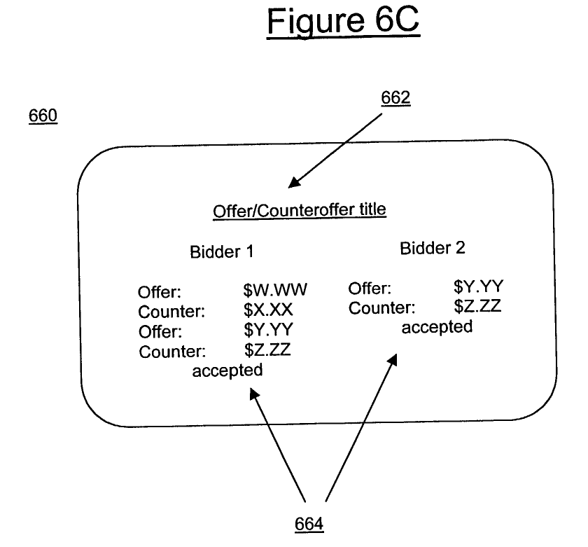

With reference to FIG. 3, at step 335, in response to the second user response, a third user interface is rendered based on the second user response and the meta-data. In one embodiment the third user interface presents the second user response specific to the negotiation type. FIGS. 6A-C illustrate exemplary screen shots of a third user interface in accordance with one embodiment of the present invention.

FIG. 6A illustrates an exemplary screenshot of a third user interface 600 for an RFQ negotiation. Third user interface 600 comprises an RFQ title 602, and RFQ information 604. It should be appreciated that the terminology used in third user interface 600 is specific to an RFQ negotiation. It should be further appreciated that third user interface 600 is rendered to display information received in an RFQ negotiation. Accordingly, RFQ information 604 displays information received as a second user response at step 330 of FIG. 3. In one embodiment, RFQ information 604 displays a plurality of quotes with all terms provided as the second user response side by side, enabling a negotiator to easily view and compare the information of each quote.

FIG. 6B illustrates an exemplary screenshot of a third user interface 630 for an auction. Third user interface 630 comprises an auction title 632 and auction information 634. It should be appreciated that the terminology used in third user interface 630 is specific to an auction. It should further be appreciated that third user interface 630 is rendered to display information received in an auction. Accordingly, auction information 634 displays information received as a second user response at step 330 of FIG. 3. In one embodiment, auction information 634 displays the competing bids received side by side, enabling a negotiator to easily view and compare the information of each bid.

FIG. 6C illustrates an exemplary screenshot of a third user interface 660 for an offer/counteroffer negotiation. Third user interface 660 comprises an offer/counteroffer title 662 and offer/counteroffer information 664. It should be appreciated that the terminology used in third user interface 660 is specific to an offer/counteroffer negotiation. It should further be appreciated that third user interface 660 is rendered to display information received in an offer/counteroffer negotiation. Accordingly, offer/counteroffer information 664 displays information received as a second user response at step 330 of FIG. 3. In one embodiment, offer/counteroffer information 664 displays all offer and counteroffer information for competing counteroffers side by side, enabling a negotiator to easily view and compare the information of each counteroffer.

### EXEMPLARY HARDWARE UPON WHICH EMBODIMENTS OF THE PRESENT INVENTION MAY BE IMPLEMENTED

Portions of the present invention are comprised of computer-readable and computer executable instructions which reside, for example, in computer-usable media of a computer system. FIG. 7 illustrates a block diagram of an exemplary computer system 700 upon which embodiments of the present invention may be implemented. Computer system 700 shows the components of a computer system in accordance with one embodiment of the present invention that provides the execution platform for implementing certain software-based functionality of the present invention. As described above, certain processes and steps of the present invention are realized, in one embodiment, as a series of instructions (e.g., software program) that reside within computer readable memory units of a computer system (e.g., system 700) and are executed by the processor(s) of system 700. When executed, the instructions cause the computer system 700 to implement the functionality of the present invention as described above.

In general, computer system 700 shows the basic components of a computer system used to implement “server” machines and “client” machines. Computer system 700 comprises an address/data bus 710 for communicating information, one or more central processors 701 coupled with the bus 710 for processing information and instructions, a computer readable volatile memory unit 702 (e.g., random access memory, static RAM, dynamic, RAM, etc.) coupled with the bus 710 for storing information and instructions for the central processor(s) 701, a computer readable non-volatile memory unit 703 (e.g., read only memory, programmable ROM, flash memory, EPROM, EEPROM, etc.) coupled with the bus 710 for storing static information and instructions for the processor(s) 701. System 700 also includes a computer readable data storage device 704 such as a magnetic or optical disk and disk drive coupled with the bus 710 for storing information and instructions. Optionally, system 700 can include a display device 705 coupled to the bus 710 for displaying information to the computer user, an alphanumeric input device 706 including alphanumeric and function keys coupled to the bus 710 for communicating information and command selections to the central processor(s) 701, a cursor control device 707 coupled to the bus for communicating user input information and command selections to the central processor(s) 701, and a signal generating device 708 coupled to the bus 710 for communicating command selections to the processor(s) 701.

The preferred embodiment of the present invention, a method and system for generating a negotiation, is thus described. While the present invention has been described in particular embodiments, it should be appreciated that the present invention should not be construed as limited by such embodiments, but rather construed according to the below claims.

1. A method for generating a negotiation comprising:
receiving a request to generate a negotiation of an item, said request comprising an indication of a negotiation type;
accessing common data and meta-data, wherein said meta-data is associated with said negotiation type, defines which data of said common data is displayed, and what terminology is used to present said common data, and wherein said common data comprises data for a plurality of negotiation types;
rendering a first user interface, specific to said negotiation type based on said common data and said meta-data associated with said negotiation type, prompting for a first user response defining a term of said negotiation;
in response to said first user response, generating said negotiation based on said first user response and said meta-data associated with said negotiation type; and
receiving another request to generate said negotiation of said item said request comprising an indication of a different negotiation type;
accessing said common data and meta-data associated with said different negotiation type;
rendering said first user interface specific to said different negotiation type based on said common data and said meta-data associated with said different negotiation type; and
in response to said first user response generating said negotiation based on said first user response and said meta-data associated with said different negotiation type.

2. A method as recited in claim 1 further comprising:
publishing said negotiation to at least one participant; and
rendering a second user interface based on said negotiation, said second user interface prompting for a second user response characterizing said term of said negotiation.

3. A method as recited in claim 2 further comprising, in response to said second user response, rendering a third user interface based on said second user response and said meta-data, said third user interface presenting said second user response specific to said negotiation type.

4. (canceled)

5. A method as recited in claim 1 wherein said negotiation type is an auction.

6. A method as recited in claim 1 wherein said negotiation type is a request for information (RFI).

7. A method as recited in claim 1 wherein said negotiation type is a request for a quote (RFQ).

8. A method as recited in claim 1 wherein said negotiation type is an offer/counteroffer negotiation.

9. A computer-readable medium having computer-readable program code embodied therein for causing a computer system to perform a method for generating a negotiation, said method comprising:
receiving a request to generate said negotiation of an item, said request comprising an indication of a negotiation type;
accessing common data and meta-data, wherein said meta-data is associated with said negotiation type, defines which data of said common data is displayed, and what terminology is used to present said common data, and wherein said common data comprises data for a plurality of negotiation types;
rendering a first user interface, specific to said negotiation type based on said common data and said meta-data associated with said negotiation type, prompting for a first user response defining a term of said negotiation;
in response to said first user response, generating said negotiation based on said first user response and said meta-data associated with said negotiation type; and
receiving another request to generate said negotiation of said item said request comprising an indication of a different negotiation type;
accessing said common data and meta-data associated with said different negotiation type;
rendering said first user interface specific to said different negotiation type based on said common data and said meta-data associated with said different negotiation type; and
in response to said first user response generating said negotiation based on said first user response and said meta-data associated with said different negotiation type.

10. A computer-readable medium as recited in claim 9 further comprising:
publishing said negotiation to at least one participant; and
rendering a second user interface based on said negotiation, said second user interface prompting for a second user response characterizing said term of said negotiation.

11. A computer-readable medium as recited in claim 10 further comprising, in response to said second user response, rendering a third user interface based on said second user response and said meta-data, said third user interface presenting said second user response specific to said negotiation type.

12. (canceled)

13. A computer-readable medium as recited in claim 9 wherein said negotiation type is an auction.

14. A computer-readable medium as recited in claim 9 wherein said negotiation type is a request for information (RFI).

15. A computer-readable medium as recited in claim 9 wherein said negotiation type is a request for a quote (RFQ).

16. A computer-readable medium as recited in claim 9 wherein said negotiation type is an offer/counteroffer negotiation.

17. A computer system comprising:
a bus;
a memory unit coupled to said bus, and
a processor coupled to said bus, said processor for executing a method for generating a negotiation, said method comprising:
receiving a request to generate said negotiation of an item, said request comprising an indication of a negotiation type;
accessing common data and meta-data, wherein said meta-data is associated with said negotiation type, defines which data of said common data is displayed, and what terminology is used to present said common data, and wherein said common data comprises data for a plurality of negotiation types;
rendering a first user interface, specific to said negotiation type based on said common data and said meta-data associated with said negotiation type, prompting for a first user response defining a term of said negotiation;
in response to said first user response generating said negotiation based on said first user response and said meta-data associated with said negotiation type; and
receiving another request to generate said negotiation of said item, said request comprising an indication of a different negotiation type;
accessing said common data and meta-data associated with said different negotiation type;
rendering said first user interface, specific to said different negotiation type based on said common data and said meta-data associated with said different negotiation type; and
in response to said first user response, generating said negotiation based on said first user response and said meta-data associated with said different negotiation type.

18. A computer system as recited in claim 17 wherein said method further comprises:
publishing said negotiation to at least one participant; and
rendering a second user interface based on said negotiation, said second user interface prompting for a second user response characterizing said term of said negotiation.

19. A computer system as recited in claim 18 wherein said method further comprises, in response to said second user response, rendering a third user interface based on said second user response and said meta-data, said third user interface presenting said second user response specific to said negotiation type.

20. A system for generating a negotiation comprising:
means for receiving a request to generate said negotiation of an item, said request comprising an indication of a negotiation type portion;
means for accessing common data and meta-data, wherein said meta-data is associated with said negotiation type, defines which data of said common data is displayed, and what terminology is used to present said common data, and wherein said common data comprises data for a plurality of negotiation types;
means for rendering a first user interface, specific to said negotiation type based on said common data and said meta-data associated with said negotiation type, prompting for a first user response defining a term of said negotiation; and
means for generating said negotiation based on said first user response and said meta-data associated with said negotiation type in response to said first user response; and
means for receiving another request to generate said negotiation of said item, said request comprising an indication of a different negotiation type;
means for accessing said common data and meta-data associated with said different negotiation type;
means for rendering said first user interface, specific to said different negotiation type based on said common data and said meta-data associated with said different negotiation type; and
means for generating said negotiation based on said first user response and said meta-data associated with said different negotiation type.

21. A system as recited in claim 20 further comprising:
means for publishing said negotiation to at least one participant; and
means for rendering a second user interface based on said negotiation, said second user interface prompting for a second user response characterizing said term of said negotiation.

22. A system as recited in claim 21 further comprising means for rendering a third user interface based on said second user response and said meta-data in response to said second user response, said third user interface presenting said second user response specific to said negotiation type.

23-30. (canceled)
